(19) United States
(12) Patent Application Publication
(10) Pub. No.: US 2022/0036592 A1
(43) Pub. Date: Feb. 3, 2022

(54) COLORIMETRIC MEASUREMENT ON A FLUIDIC SAMPLE WITH AN IMAGE SENSOR

(71) Applicant: VOGO, Montpellier (FR)

(72) Inventors: Christophe DAUDIN, Montpellier (FR); Christophe CARNIEL, Castelnau le Lez (FR); Daniel DEDISSE, Prades le Lez (FR); Pascal SAGUIN, Crets en Belledonne (FR); Pierre KEIFLIN, Mauguio-Carnon (FR)

(73) Assignee: VOGO, Montpellier (FR)

(21) Appl. No.: 17/390,382

(22) Filed: Jul. 30, 2021

(30) Foreign Application Priority Data
Jul. 30, 2020 (EP) 20305875.5

(51) Int. Cl. G06T 7/90; G06T 7/00

(52) U.S. Cl. CPC G06T 7/90; G06T 7/0012; G06T 2207/20081; G06T 2207/30004; G06T 2207/10024

(57) ABSTRACT

A method for identifying a result of a test carried out from a fluidic sample, the fluidic sample being contained in a translucent container, the container being positioned on an area of interest of the container and opposite a dedicated area of the support. Ranges of reference colorimetric values and geometric references are printed on the support which also includes calibration colorimetric values printed in the at least one color calibration area.

### FIELD OF THE INVENTION

The present invention concerns a method as well as a device for identifying a result of a test carried out from a fluidic sample.

### PRIOR ART

It is known to proceed with fluidic samples in order to carry out tests, for example in the medical analysis field. The test may consist placing the fluidic sample in the presence of a reactant. For example, the result of the tests may be identified in a colorimetric way, in particular by soaking a substrate comprising the reactant in the sample. The identification of the result by a coloration on the substrate may be assisted by a processing of an image of the substrate.

Nonetheless, the manufacture of a substrate coated with a reactant requires the set-up of a complex manufacturing process.

The present invention aims at solving all or part of the aforementioned zo drawbacks.

### DISCLOSURE OF THE INVENTION

To this end, an object of the present invention is a method according to the aforementioned type, enabling the identification of a result of a test carried out from a fluidic sample, the fluidic sample being contained in a translucent container and the method comprising the following steps:
Provision of a support for the container containing the fluidic sample;
Positioning of the container opposite a dedicated area of the support;
Capture of a digital image of the support and of the container positioned on the support;
Determination of an area of interest of the container occupied by at least one portion of interest of the container in the digital image;
Extraction of a colorimetric information relating to the area of interest of the container in the digital image;
Identification of the result of the test based on the analysis of the colorimetric information.

The arrangements according to the invention allow identifying the result of a test carried out directly from a fluidic sample.

The method may further present one or more of the following features, considered separately or in combination.

According to one possibility, the translucent container is tightly closed. According to one example, a plug is affixed onto the container to close it. This makes it possible to perform the test by disposing the container horizontally or vertically on the support S.

The portion of interest may correspond to a translucent portion of the container. In particular, the portion of interest may correspond to a translucent portion comprising the fluidic sample.

In other words, the determination of the area of interest of the container occupied by a portion of interest of the container in the image corresponds to the determination of a position or of a location of a portion of interest of the container in the image of the container.

In other words, the area of interest of the container is an image portion corresponding to a portion of the container containing a fluidic sample.

According to one implementation, the step of extracting a colorimetric information relating to the area of interest of the container is carried out based on the determination of a colorimetric indicator relating to a set of sub-areas of the area of interest of the container. A sub-area may correspond to one pixel or to a set of pixels of the digital image.

According to one implementation, the colorimetric indicator comprises one or several colorimetric coordinate(s) of a sub-area of a digital image in a colorimetric reference frame.

According to one implementation, the colorimetric indicator further comprises geometric coordinates of the abscissa and ordinate of a sub-area of a digital image.

According to one implementation, the colorimetric indicator is expressed in a HSV—standing for Hue Saturation Value—reference frame.

According to one possibility, the colorimetric indicator refers to a colorimetric indicator H of a sub-area of a digital image.

According to one possibility, the colorimetric indicator refers to a colorimetric coordinate H and geometric coordinates of the abscissa and of the ordinate of a sub-area of a digital image.

According to one possibility, the colorimetric indicator refers to colorimetric coordinates H, S and V of a sub-area of a digital image in the HSV colorimetric reference frame.

According to one implementation, the method comprises a step of transposition between a first colorimetric reference frame, for example RGB, and a second colorimetric reference frame so as to express the colorimetric indicator in a second colorimetric reference frame HSV.

According to one implementation, the extraction of the colorimetric information comprises the steps of expressing a distribution of the sub-areas of the area of interest as a function of values of the colorimetric indicator and of determining the colorimetric information based on a computation of a concentration of sub-areas in the distribution.

The determination of the colorimetric information based on a computation of a sub-area concentration in the distribution allows eliminating an artifact present in the area of interest of the container. Indeed, these arrangements allow determining the colorimetric information based on a homogeneous area of the area of interest, while not considering sub-areas corresponding to artifacts.

According to one possibility, the artifact is a bubble or a reflection.

According to one possibility, the extraction of the colorimetric information comprises a determination of an interval or of a distribution space portion in which a criterion relating to the sub-area concentration is met and a determination of the colorimetric information according to the values of the colorimetric indicators corresponding to the sub-areas comprised in the interval or the space portion.

According to one embodiment, the criterion relating to the concentration corresponds, for example, to a threshold being exceeded or to a maximum value.

According to one embodiment, the determination of the interval or of the space portion is carried out into several successive steps, corresponding to meeting of several successive criteria.

According to one implementation, the at least one colorimetric indicator refers to the colorimetric coordinate H in the HSV colorimetric reference frame and the distribution refers to a planar curve of a number of pixels as a function of a value of the colorimetric coordinate.

According to one implementation, the at least one colorimetric indicator refers to the colorimetric coordinate and the abscissa and ordinate geometric coordinates and the distribution refers to a curve in an at least 2-dimensional space.

According to one implementation, a classification algorithm is implemented in order to group together in spheres sub-areas having close coordinate values.

As example, a sphere where a product of a diameter thereof by a distance between the center of this sphere and an axis of the coordinate H is the highest is retained to compute a value of the coordinate that represents the colorimetric information to be extracted.

Indeed, this product refers to the largest number of sub-areas representing a bright color (with a high value of saturation and therefore of the coordinate S) that could be distinguished in the context of the method.

In this case, the coordinate H is measured in degrees as being an angle between the line passing through the center of the sphere and a point located on the axis of the coordinate V, and an axis of the coordinate S.

According to one possibility, the step of extracting the colorimetric information comprises a step of excluding the sub-areas for which a value of the colorimetric indicator is lower than a limit value and/or higher than a threshold value of the at least one colorimetric indicator. This arrangement allows

According to one possibility, the step of determining an area of interest of the container occupied by at least one portion of interest of the container in the image is carried out based on geometric references present on the support.

According to one possibility, the occupied area of interest of the container is estimated from the dedicated area.

According to one implementation, the result of the test may take on several test result values, a test result value corresponding to a range of reference colorimetric values amongst a plurality of ranges of reference colorimetric values, and wherein the step of identifying the result of the test based on the analysis of the colorimetric information comprises a comparison of a value of the colorimetric information with the ranges of reference colorimetric values.

According to one implementation, the ranges of reference colorimetric values are defined by limit reference colorimetric values recorded in a processing unit.

According to one possibility, the method comprises steps of determining at least one color calibration area comprising printing of calibration colorimetric values printed on the support, extracting a plurality of calibration colorimetric values printed in the at least one color calibration area, comparing between calibration colorimetric values recorded in the processing unit and the calibration colorimetric values printed on the support, determining a correction of colorimetric values based on the comparison, applying the correction of colorimetric values to the colorimetric indicators of the area of interest.

According to one embodiment, the correction is carried out by the application of a correction matrix.

According to one embodiment, the method further comprises the step of determining at least one area with ranges corresponding to ranges of reference colorimetric values printed on the support and wherein the comparison of a value of the colorimetric information with the ranges of reference colorimetric values comprises a comparison of the colorimetric information with the reference colorimetric ranges printed on the support.

According to one possibility, the step of identifying the result of the test further comprises a first substep of identifying the test result based on colorimetric ranges recorded in the processing unit, a second substep of identifying the test result based on colorimetric ranges printed on the support and a substep of comparing the results of the identification substeps taking into account a result of the first substep and a result of the second substep.

According to one implementation, the method comprises a step of counting a number of sub-areas belonging to each range of reference colorimetric values.

According to one possibility, the reference color ranges take into account a color of the dedicated area of the support.

According to one implementation, the step of identifying the result of the test is carried out based on the analysis of the colorimetric information and based on a confidence indicator obtained by a machine learning program.

According to one implementation, the method comprises a step of transmitting an information set relating to a result of the test towards the machine learning program, a step of analyzing the information set by the machine learning program, and a step of generating by the machine learning program a confidence indicator relating to the result of the test.

According to one implementation, the method comprises a learning phase comprising the steps of storing a plurality of information sets relating to a plurality of tests and of the corresponding test results in a dedicated computer location, gathering reference test result values for each of the tests of the plurality of tests, injection a plurality of information sets relating to the plurality of tests into a machine learning program and analyzing the plurality of information sets and of the test results by a machine learning program.

According to one embodiment, it is proceeded with a transfer of the result of the test in a dedicated digital location.

According to one possibility, the step of identifying the result of the test further comprises a third substep of identifying the test result based on the analysis of the colorimetric information and based on the obtained confidence indicator by a machine learning program, and wherein the substep of comparing the results of the identification substeps takes into account a result of the third identification substep.

Another object of the present invention is a device for identifying a result of a test carried out from a fluidic sample comprising:
a translucent container intended to contain the fluidic sample;
a support for the container containing the fluidic sample comprising a dedicated area of the support opposite which the container is placed;
a device for capturing a digital image of the container comprising an area of interest of said container;
and a unit for processing the digital image arranged so as to implement the method.

The device may further present one or more of the following features, considered separately or in combination.

According to one embodiment, the support for the container includes at least one area with a calibration colorimetric value and at least one identification pattern.

According to one possibility, the translucent container is tightly closed. According to one example, a plug is affixed onto the container to close it. This makes it possible to perform the test by disposing the container horizontally or vertically on the support.

According to one embodiment, the identification pattern may consist of a barcode or QR-code type pattern.

### BRIEF DESCRIPTION OF THE FIGURES

The invention will be better understood using the detailed description that is disclosed herein below with reference to the appended drawings in which:

FIG. 1 is a flowchart presenting general steps carried out during the execution of a described method.

FIG. 2 is a representation of a support over which a container containing a fluidic sample is placed.

FIG. 3 is a sequence of images presenting steps of extracting a colorimetric information to be analyzed.

FIG. 4 is a sequence of images presenting an extraction of a colorimetric information according to a first implementation of the method described in [FIG. 1].

FIG. 5 is a sequence of images presenting an extraction of a colorimetric information according to a second implementation of the method described in [FIG. 1].

FIG. 6 is a sequence of images presenting an extraction of a colorimetric information according to a third implementation of the method described in [FIG. 1].

FIG. 7 is a diagram representing values of a colorimetric indicator relating to ranges of reference colorimetric values.

FIG. 8 is a representation of a support on which a dedicated area of the support features a background color.

FIG. 9 is a flowchart presenting steps to be executed for an identification of the colorimetric information according to an embodiment of the method described in [FIG. 1].

FIG. 10 is a flowchart presenting a step to be executed for an identification of the colorimetric information according to an embodiment of the method described in [FIG. 1].

FIG. 11 is a diagram representing the identification of the colorimetric information according to an implementation of the method described in [FIG. 1] and using a machine learning program.

FIG. 12 is a flowchart presenting steps executed during a learning phase of the machine learning program described in [FIG. 11].

FIG. 13 is a flowchart presenting steps executed during a phase of using the machine learning program described in [FIG. 11] for the implementation of the method described in [FIG. 1].

### DESCRIPTION WITH REFERENCE TO THE FIGURES

In the following detailed description of the figures defined hereinabove, the same elements or the elements filling identical functions may keep the same reference numerals so as to simplify the understanding of the invention.

Description of the Context

The method for identifying a result of a test may follow a sampling and application of the reactant. As example, the sample may consist of a body fluid sample such as for example a blood or saliva sample. In particular, in the case of a saliva sample, the reactant may be intended to detect the presence of a pathogen, such as a for example a virus.

Thus, test tubes or containers containing a few milliliters of a reactant sensitive to the presence of a virus are made available to the medical staff. Salivary sampling is carried out followed by mixing of the salivary sample with the reactant in a test tube or container. The container containing the reactant and the saliva may be heated up, for example for 30 minutes at 60°. The action of the reactant gives a color to the mixture in the container which corresponds to a positive or negative result, or to an ambiguous result.

It should be noted that the method described hereinafter could be used for other test result identification applications on fluidic samples in which the color or the optical properties of the sample or of the mixture of the sample with a reactant characterize the result of the test.

General Description of the Method

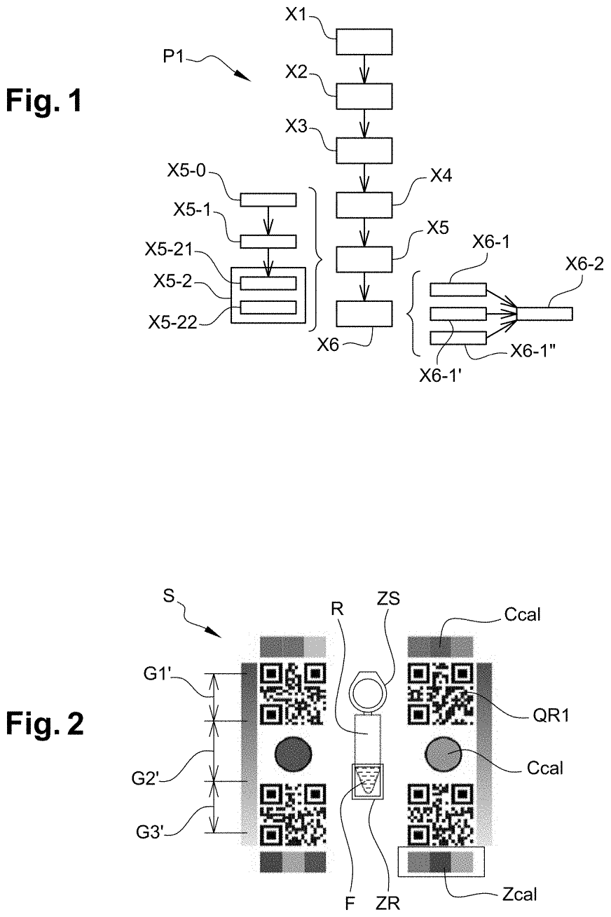

In FIG. 1, steps of execution of the method P1 for identifying the result of the test are presented.

Thus, a first step X1 comprises the supply X1 of a support S for a container R containing a fluidic sample F.

During a second step X2, the positioning of the container R opposite a dedicated area ZS of the support S is performed. The translucent container R may be tightly closed, for example by affixing a plug onto the container. This makes it possible to perform the test by disposing the container horizontally or vertically on the support S.

A third step X3 comprises a capture X3 of a digital image of the support S and of the container R positioned over the support S, for example by means of a camera or of a mobile communication terminal.

In a step X4, it is proceeded with the determination of an area of interest of the container ZR occupied by at least one portion of interest of the container in the digital image. The portion of interest may correspond to a translucent portion of the container. In particular, the portion of interest may correspond to a translucent portion comprising the fluidic sample F. In other words, the determination of the area of interest ZR of the container occupied by a portion of interest of the container in the image corresponds to the determination of a position or of a location of a portion of interest of the container in the image of the container. Thus, the area of interest of the container ZR is a image portion corresponding to a portion of the container containing a fluidic sample F.

The step X4 of determining an area of interest of the container ZR occupied by at least one portion of interest of the container in the image is carried out based on geometric references QR1 present on the support S.

According to one possibility, the geometric references QR1 of FIG. 2 present on the support S refer to a plurality of QR codes, for example four QR codes.

According to one possibility, the position of the area of interest of the container ZR shown in FIG. 2 is defined by the position of the plurality of QR codes, for example by an intersection of lines D1, D2 connecting the diagonally opposite QR codes on the support S.

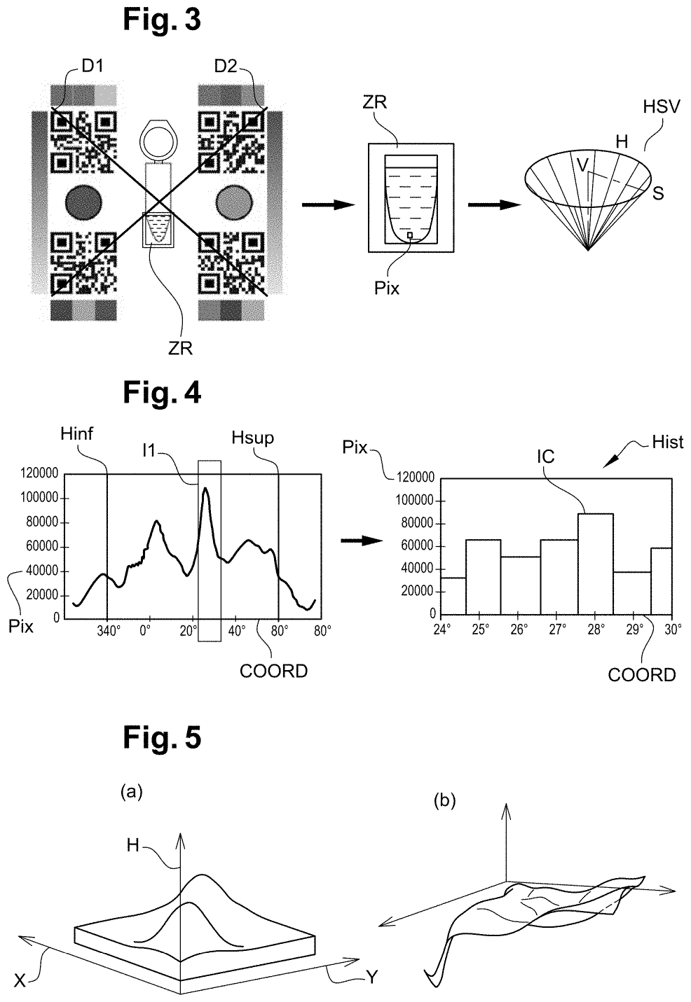

From the intersection of the lines D1, D2, shown in FIG. 3, a plurality of sub-areas Pix constituting the area of interest ZR of the container is extracted.

The occupied area of interest of the container ZR may be estimated from the dedicated area of the support ZS shown in FIG. 2 whose position is known with respect to the position of the geometric references.

Afterwards, it is proceeded with an extraction of a colorimetric information IC relating to the area of interest of the container ZR in the digital image during a fifth step X5.

Finally, a sixth step comprises an identification X6 of the result of the test based on the analysis of the colorimetric information IC.

Extraction of the Colorimetric Information

In the method P1, the step X5 of extracting a colorimetric information IC relating to the area of interest of the container ZR is carried out based on the determination of a colorimetric indicator COORD relating to a set of sub-areas Pix of the area of interest of the container ZR. By colorimetric information, it should be understood a value of a dominating colorimetric indicator COORD related to the fluidic sample F. For example, a sub-area Pix of a digital image may refer to one pixel.

A colorimetric indicator COORD may comprise a colorimetric coordinate H or several colorimetric coordinates H, S, V of a sub-area Pix of a digital image in a colorimetric reference frame HSV.

According to one possibility, the colorimetric indicators COORD are expressed in a colorimetric reference frame HSV, for example such as that of FIG. 3.

According to one possibility, the at least one colorimetric indicator COORD refers to a colorimetric coordinate H of a sub-area Pix of a digital image.

According to another possibility, the at least one colorimetric indicator COORD refers to a colorimetric coordinate H and geometric coordinates of the abscissa X and of the ordinate Y of a sub-area Pix of a digital image.

According to another possibility, the at least one colorimetric indicator COORD refers to the colorimetric coordinates H, S and V of a sub-area Pix of a digital image in the colorimetric reference frame HSV.

The method P1 may further comprise a step of transposition between a first colorimetric reference frame, for example RGB, and a second colorimetric reference frame so as to express the colorimetric indicators in a second colorimetric reference frame HSV. Indeed, the digital image may be captured using a capturing device, for example a CMOS-type sensor, which outputs images in a RGB reference frame. To measure a colorimetric value, a HSV—standing for Hue Saturation Value—reference frame may be used. In the HSV reference frame, a colorimetric coordinate is extracted in order to obtain the colorimetric information relating to the area of interest ZR. The switch from the RGB reference frame into the HSV reference frame, and vice versa, is done through a series of computations known in the state of the art.

FIG. 3 illustrates the determination of the area of interest ZR of the container occupied by a portion of interest of the container in the digital image from the intersection of the lines D1, D2, the representation of the area of interest ZR of the container as a set of sub-areas Pix in the digital image and the transposition of the area of interest ZR of the container in a colorimetric reference frame HSV.

In particular, the step X5 of extracting the colorimetric information comprises:
a step X5-1 of expressing a distribution of the sub-areas of the area of interest ZR as a function of values of the colorimetric indicator COORD,
a step X5-2 of determining the colorimetric information IC based on a computation of a sub-area concentration Pix in the distribution.

The step of extracting the colorimetric information may also comprise a step X5-0 of excluding the sub-areas Pix for which a value of the colorimetric indicator COORD is lower than a limit value Hsup and/or higher than a threshold value Hinf of the at least one colorimetric indicator COORD. For example, this exclusion step may take place before step X5-1 or before step X5-2.

The step X5 of extracting a colorimetric information IC relating to the area of interest of the container ZR based on a computation of a sub-area concentration in the distribution may allow eliminating an artifact present in the area of interest ZR of the container such as for example a bubble or a reflection. Different implementations of the extraction step are described hereinafter.

A. First Mode of Extraction of the Colorimetric Information

FIG. 4 shows a first mode of extraction of the colorimetric information IC from the digital image wherein the colorimetric indicator COORD refers to the colorimetric coordinate H, measured in degrees for example in the colorimetric reference frame HSV and the distribution refers to a curve of a number of sub-areas Pix as a function of a value of the colorimetric coordinate H.

In this mode of extraction of the colorimetric information IC, it is first proceeded with the exclusion X5-0 of the sub-areas Pix for which a value of the colorimetric indicator COORD is lower than a limit value Hsup and/or higher than a threshold value Hinf of the at least one colorimetric indicator COORD as shown in FIG. 4.

The step X5-1 of expressing a distribution of the sub-areas of the area of interest ZR as a function of values of the colorimetric indicator COORD is carried out by indicating a number of sub-areas Pix for each value of the colorimetric indicator COORD.

The step X5-2 of determining the colorimetric information IC based on a computation of a concentration of sub-areas Pix in the distribution is then carried out according to the following two steps:
a step X5-21 of determining an interval or of a distribution space portion in which a criterion relating to the sub-area concentration is met;
a step X5-22 of determining the colorimetric information according to the values of the colorimetric indicators corresponding to the sub-areas comprised in the interval or the space portion 11.

First, the step X5-21 of determining a distribution interval in which a criterion relating to the sub-area concentration is met is carried out. In particular, based on the defined distribution, a first analysis pitch related to the colorimetric coordinate H is used. For example, the first analysis pitch may have a value substantially equal to 6°. A computation of an average of the number of sub-areas within an interval corresponding to the pitch is performed, in particular a computation of a rolling average on values of the colorimetric coordinate H. Thus, a first interval s determined using a criterion corresponding for example to the highest average value.

It is possible to proceed with a second step of determining an interval by carrying out an analysis on the first interval using a second analysis pitch smaller than the first analysis pitch. The histogram Hist of FIG. 4 represents the completion of this analysis. For example, the second analysis pitch may have a value substantially equal to 1°. For example, it is possible to select a second interval using a criterion corresponding for example to the highest value of the number of sub-areas in this 1° pitch interval.

The step X5-22 of determining the colorimetric information according to the values of the colorimetric indicators corresponding to the sub-areas comprised in the interval may be carried out by defining the colorimetric information IC such as a value of the colorimetric coordinate H of the second interval comprising the largest number of sub-areas is retained, for example the median value of this interval. In the example of the histogram of FIG. 4, this value would correspond to 28°. Hence, the colorimetric information IC relating to the digital image is formed by the value of the prevailing colorimetric coordinate H within the second analysis interval and relevant as it relates to a colorimetric value that could be identified in the ranges of reference colorimetric values G1, G2, G3.

B. Second Mode of Extraction of the Colorimetric Information

In this mode of extraction of the colorimetric information IC shown in FIG. 5, the step X5-1 of expressing a distribution of the sub-areas of the area of interest ZR as a function of values of the colorimetric indicator COORD is carried out at first. In particular, in this case, the colorimetric indicator comprises a value of H for the sub-area and values of geometric coordinates of the abscissa X and of the ordinate Y defining the position of the sub-area in the image. In practice, the expression of this distribution corresponds to the projection of the image in a three-dimensional space as represented in FIGS. 5a and 5b.

The step X5-2 of determining the colorimetric information IC based on a computation of a sub-area concentration Pix in the distribution is then carried out.

In particular, based on the defined distribution, an analysis is carried out using analysis subsets, each analysis subset being defined by geometric coordinates of the abscissa X and the ordinate Y and constituted by a plurality of sub-areas Pix, for example 49 pixels or 81 pixels. The entire area of interest of the image is covered by the sub-set for example with a 1 pixel pitch.

Within each subset, the first mode of extraction of the colorimetric information is implemented in order to identify, for each analysis subset, the colorimetric coordinate H representative of the analysis subset and the number of pixels or sub-areas corresponding to this value. The number of subsets having the same value of the colorimetric coordinate H is counted. The largest number of subsets then determines the colorimetric information IC related to the digital image.

C. Third Mode of Extraction of the Colorimetric Information

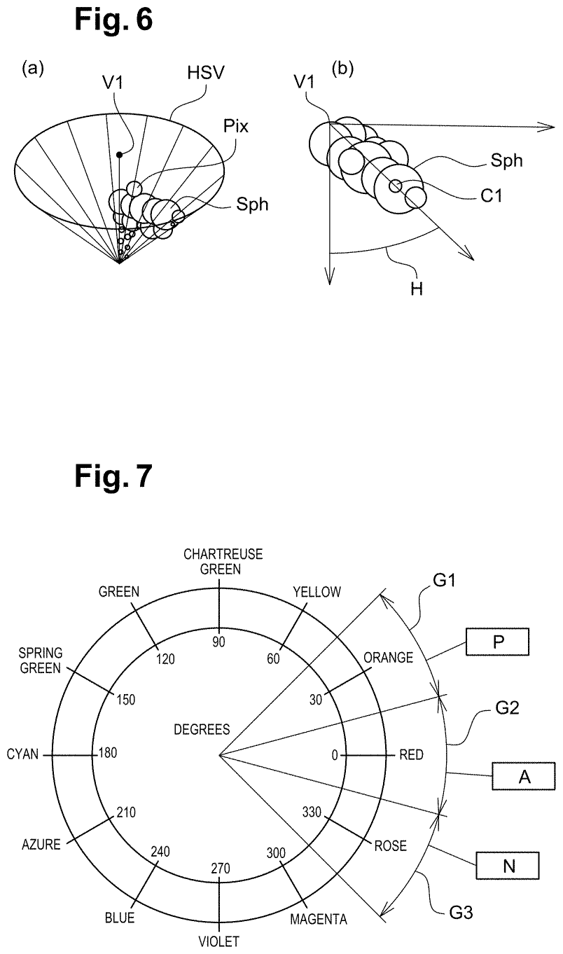

In this mode of extraction of the colorimetric information IC shown in FIG. 6, the step X5-1 of expressing a distribution of the sub-areas of the area of interest ZR as a function of values of the colorimetric indicator COORD is carried out at first. The colorimetric indicator corresponds herein to values of the colorimetric coordinates H, S, V of the sub-areas Pix related to the digital image. These values of the colorimetric indicator are projected in the colorimetric reference frame HSV.

The step X5-2 of determining the colorimetric information IC based on a computation of a concentration of sub-areas Pix in the distribution is then carried out according to the following two steps:
a step X5-21 of determining an interval or of a distribution space portion in which a criterion relating to the sub-area concentration is met;
a step X5-22 of determining the colorimetric information according to the values of the colorimetric indicators corresponding to the sub-areas comprised in the interval or the space portion 11.

First, the step X5-21 of determining a distribution interval in which a criterion relating to the sub-area concentration is met is carried out. In particular, based on the defined distribution. A classification algorithm is then executed in order to group together the sub-areas Pix having closes values of the coordinates H, S, V in space portions in the form of spheres.

The used criterion may consist in retaining a sphere Sph with a center C1 where the product of a diameter thereof by a distance between the center C1 of this sphere and an axis of the coordinate V is the highest, is retained.

Indeed, this product refers to the largest number of sub-areas Pix representing a bright color (with a high value of saturation and therefore of the coordinate S) that could be distinguished.

In this case, the coordinate H is measured in degrees as an angle between the line passing through the center C1 of the sphere Sph and a point V1 located on the axis of the coordinate V, and an axis of the coordinate S. This coordinate H then represents the colorimetric information IC.

Identification of the Result of the Test

Once the colorimetric information IC has been extracted from the area of interest of the container, it is compared with ranges of reference colorimetric values G1, G2, G3, G1′, G2′, G3′ in order to obtain the result of the test.

The result of the test may take on several test result values P, N, A, referring to a positive, negative or ambiguous test result, and a test result value corresponding to a range of reference colorimetric values amongst a plurality of ranges of reference colorimetric values G1, G2, G3, G1′, G2′, G3′ shown in FIGS. 2 and 7 and wherein the step X6 of identifying the result of the test based on the analysis of the colorimetric information IC comprises a comparison of a value of the colorimetric information with the ranges of reference colorimetric values G1, G2, G3, G1′, G2′, G3′

According to one implementation, the ranges of reference colorimetric values G1, G2, G3 are defined by limit reference colorimetric values in a processing unit EC whereas the ranges of reference colorimetric values G1′, G2′, G3′ are defined by limit reference colorimetric values printed on the support S.

The retained value of the colorimetric indicator IC may be affected in particular depending on 2 parameters:
the luminosity conditions: Direct Sunlight, Dark space . . . .
the characteristics of the CMOS sensors of the cameras which have a wide discrepancy between brands and between the products of the same brand.

To reduce the measurement errors due to these disturbances, two identification modes taking into account these disturbances are defined hereinbelow.

Absolute Mode

A first mode of identification of the result of the test represented in FIG. 9, called «absolute mode», comprises steps of determining MA1 at least one color calibration area Zcal comprising printing of calibration colorimetric values Ccal printed on the support S, of extracting MA2 a plurality of calibration colorimetric values Ccal printed in the at least one color calibration area Zcal, of comparing MA3 calibration colorimetric values recorded in the processing unit EC and the calibration colorimetric values Ccal printed on the support S, a determination Ma of a correction of colorimetric values based on the comparison, and application MA5 of the correction of colorimetric values to the colorimetric indicators of the area of interest ZR.

According to one implementation, the correction is carried out by the application of a correction matrix.

Relative Mode

A second mode of identification of the result of the test, called «relative mode», may comprise a step of determining MR1 at least one range area corresponding to ranges of reference colorimetric values G1′, G2′, G3′ printed on the support S, and wherein the comparison of a value of the colorimetric information IC with the ranges of reference colorimetric values G1′, G2′, G3′ comprises a comparison of the colorimetric information IC with the reference colorimetric ranges G1′, G2′, G3′ printed on the support S.

Combination of the Relative Mode and of the Absolute Mode

The step X6 of identifying the result of the test may further comprise a first substep X6-1 of identifying the test result based on colorimetric ranges G1, G2, G3, a second substep X6-1′ of identifying the test result based on colorimetric ranges G1′, G2′, G3′, and a substep X6-2 of comparing the results of the identification substeps taking into account a result of the first substep X6-1 and a result of the second substep X6-1′.

Thus, the identifications according to the two modes defined hereinabove are extracted in parallel.

In the case where the modes do not give the same result (Positive or Ambiguous or Negative), the method is launched again from the beginning from the image capture.

It is possible to provide for the test to be defined as non-achievable if after a predefined number of attempts, the two modes do not give the same result.

Identification of the Test Result by Counting the Number of Sub-Areas

Moreover, it is possible to identify the result of the test by a step of counting a number of sub-areas belonging to each range of reference colorimetric values G1, G2, G3.

Consideration of the Background Color

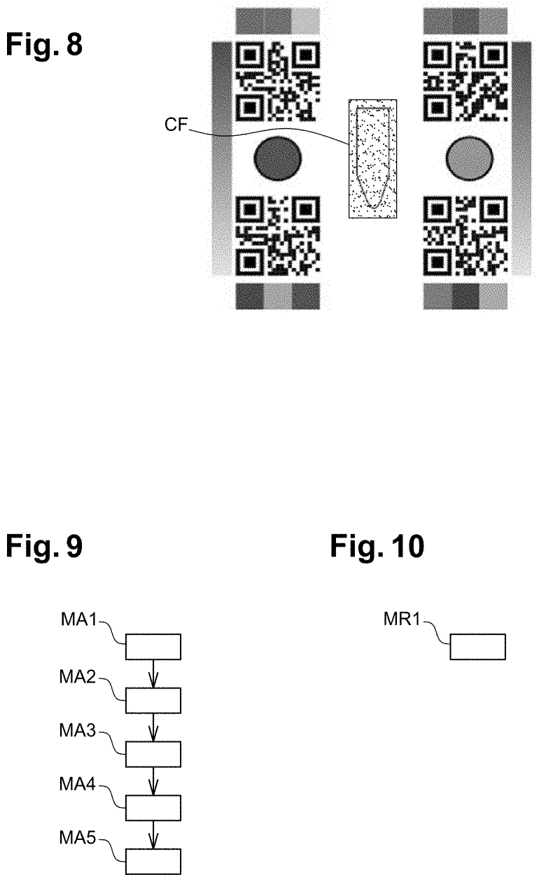

According to one possibility, the ranges of reference colors G1′, G2′, G3′ take into account a color CF of the dedicated area of the support ZS as shown in FIG. 8, it is then said that the identification of the result of the test is done through a measurement of the turbidity of the fluidic sample F.

Use of a Machine Learning Program

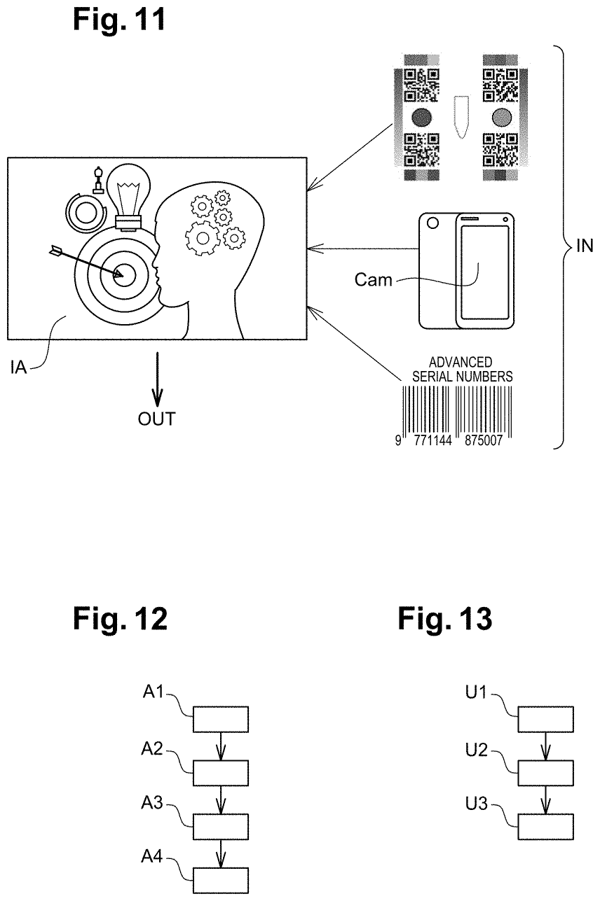

The step X6 of identifying the result of the test may be carried out based on the analysis of the colorimetric information IC and based on a confidence indicator OUT obtained by a machine learning program IA as shown in FIG. 11.

Thus, the use of a machine learning program to identify the result of the test may comprise a use phase comprising a step U1 of transmitting an information set IN relating to a result of the test T towards the machine learning program IA, a step U2 of analyzing the information set IN by the machine learning program IA, and a step U3 of generating a confidence indicator OUT relating to the result of the test T by the machine learning program IA.

According to one possibility, the identification of the result of the test T may be supervised by a human operator, for example by a person trained for the considered test such as a physician, based on the digital image and the confidence indicator OUT.

In particular, the information set may comprise the digital image or a portion thereof, one or several characteristics of the image capturing device such as for example an identification by a serial number.

The method P1 may further comprise a learning phase comprising a step A1 of storing a plurality of information sets IN relating to a plurality of tests and of the corresponding test results in a dedicated computer location, a step A2 of gathering reference test result values for each of the tests of the plurality of tests, an injection A3 of a plurality of information sets IN relating to the plurality of tests into a machine learning program IA, a step A4 of analyzing the plurality of information sets IN and of the test results by a machine learning program IA.

According to one implementation, it is proceeded with a transfer of the result of the test in a dedicated digital location.

Thus, the step X6 of identifying the result of the test may further comprise a substep X6-1″ of identifying the test result based on the analysis of the colorimetric information IC and based on the confidence indicator OUT obtained by a machine learning program IA, and wherein the substep X6-2 of comparing the results of the identification substeps takes into account a result of the identification substep X6-1″.

Hence, several modes for considering the analysis by the machine learning program are possible.

According to a first possibility, one or two mode(s) of identification of the result of the test based on the colorimetric information according to steps X6-1 and X6-1′ is/are implemented. The machine learning program is used in the case where an ambiguous result is identified, in order to define whether positive or negative result could be identified based on training on real-life photos.

According to a second possibility, one or two modes of identification of the result of the test based on the colorimetric information according to steps X6-1 and X6-1′ are implemented. In any case, the machine learning program is used in order to give a result based on training on real-life photos. Thus, the identifications according to the two or three modes are executed in parallel. If the modes do not give the same result (Positive or Ambiguous or Negative), the method is launched again from the beginning from the image capture. It is possible to provide for the test to be defined as non-achievable if after a predefined number of attempts, the different modes do not give the same result.

According to a third possibility, one or two mode(s) of identification of the result of the test based on the colorimetric information according to steps X6-1 and X6-1′ is/are implemented. In any case, the machine learning program is used in order to give a result based on training on real-life photos. Thus, the identifications according to the two or three modes are executed in parallel. A weight is assigned to each mode, the final result being given according to the weight of each mode.

Device for Identifying the Result of the Test

For the implementation of the method P1, a device D for identifying a result of a test T carried out from a fluidic sample F is used comprising a translucent container R intended to contain the fluidic sample F, a support S for the container R containing the fluidic sample F comprising a dedicated area of the support ZS opposite which the container R is placed, a device Cam for capturing a digital image of the container R comprising an area of interest ZR of said container R, and a unit EC for processing the digital image arranged so as to implement the method P1.

The support S for the container R shown in FIG. 2 includes at least one area Zcal with a calibration colorimetric value Ccal and at least one identification pattern QR1.

According to one possibility, the translucent container R is tightly closed. According to one example, a plug is affixed onto the container to close it. This makes it possible to perform the test by disposing the container horizontally or vertically on the support S.

According to one embodiment, the identification pattern may consist of a barcode or QR-code type pattern.

For example, the container may consist of a test tube and the means for capturing a digital image may consist of a smartphone-type phone.

Although the invention has been described in connection with particular embodiments, it is obvious that it is not limited thereto and that it encompasses all technical equivalents of the described means as well as their combinations if theses fall within the scope of the invention.

1. A method for identifying a result of a test carried out from a fluidic, sample, the fluidic sample being contained in a translucent container and the method comprising the following steps:
provision of a support for the container containing the fluidic sample;
positioning of the container opposite a dedicated area of the support;
capture of a digital image of the support and of the container positioned on the support;
determination of an area of interest of the container occupied by at least one portion of interest of the container in the digital image;
extraction of a colorimetric information relating to the area of interest of the container in the digital image, so that said extraction is configured to eliminate an artifact present in the area of interest of the container;
identification of the result of the test based on the analysis of the colorimetric information.

2. The identification method according to claim 1, wherein the step of extracting a colorimetric information relating to the area of interest of the container is carried out based on the determination of a colorimetric indicator relating to a set of sub-areas of the area of interest of the container.

3. The identification method according to claim 1, wherein the colorimetric indicator comprises one or several colorimetric coordinate(s) of a sub-area of a digital image in a colorimetric reference frame.

4. The identification method according to claim 3, wherein the colorimetric indicator further comprises geometric coordinates of the abscissa and ordinate of a sub-area of a digital image.

5. The identification method according to claim 1, wherein the extraction of the colorimetric information comprises the following steps:
expression of a distribution of the sub-areas of the area of interest as a function of values of the colorimetric indicator;
determination of the colorimetric information based on a computation of a concentration of sub-areas in the distribution.

6. The identification method according to claim 5, wherein the step of determining the colorimetric information comprises:
determination of an interval or of a distribution space portion in which a criterion relating to the sub-area concentration is met;
determination of the colorimetric information according to the values of the colorimetric indicators corresponding to the sub-areas comprised in the interval or the space portion.

7. The identification method according to claim 1, wherein the step of extracting the colorimetric information comprises a step of excluding the sub-areas for which a value of the colorimetric indicator is lower than a limit value and/or higher than a threshold value of the at least one colorimetric indicator.

8. The identification method according to claim 1, wherein the result of the test may take on several test result values, a test result value corresponding to a range of reference colorimetric values amongst a plurality of ranges of reference colorimetric values, and wherein the step of identifying the result of the test based on the analysis of the colorimetric information comprises a comparison of a value of the colorimetric information with the ranges of reference colorimetric values values.

9. The identification method according to claim 8, wherein the ranges of reference colorimetric values are defined by limit reference colorimetric values recorded in a processing unit.

10. The identification method according to claim 9, further comprising the steps:
determination of at least one color calibration area comprising printing of calibration colorimetric values printed on the support;
extraction of a plurality of calibration colorimetric values printed in the at least one color calibration area;
comparison between calibration colorimetric values recorded in the processing unit and the calibration colorimetric values printed on the support;
determination of a correction of colorimetric values based on the comparison;
application of the correction of colorimetric values to the colorimetric indicators of the area of interest.

11. The identification method according to claim 8, further comprising the following step:
determination of at least one area with ranges corresponding to ranges of reference colorimetric values printed on the support;
and wherein the comparison of a value of the colorimetric information with the ranges of reference colorimetric values comprises a comparison of the colorimetric information with the reference colorimetric ranges printed on the support.

12. The identification method according to claim 8, wherein the reference color ranges take into account a color of the dedicated area of support.

13. The identification method according to claim 1, wherein the step of identifying the result of the test is carried out based on the analysis of the colorimetric information and based on a confidence indicator obtained by a machine learning program.

14. The identification method according to claim 13, comprising the following steps:
transmission of an information set relating to a result of the test towards the machine learning program;
analysis of the information set by the machine learning program;
generation by the machine learning program of a confidence indicator relating to the result of the test.

15. The identification method according to claim 13, comprising a learning phase comprising the following steps:
storage of a plurality of information sets relating to a plurality of tests and of the corresponding test results in a dedicated computer location;
gathering of reference test result values for each of the tests of the plurality of tests;
injection of a plurality of information sets relating to the plurality of tests into a machine learning program;
analysis of the plurality of information sets and of the test results by a machine learning program.
